(19) United States
(12) Patent Application Publication
(10) Pub. No.: US 2006/0181372 A1
(43) Pub. Date: Aug. 17, 2006

(54) Blow-out air current guide and air current blow-out apparatus

(75) Inventor: Keisuke Nishizawa, Nerima-ku (JP)

Correspondence Address: KODA & ANDROLIA, 2029 CENTURY PARK EAST, SUITE 1140, LOS ANGELES, CA, 90067, US

(73) Assignee: Seiho International, Inc.

(21) Appl. No.: 11/347,480

(22) Filed: Feb. 3, 2006

(30) Foreign Application Priority Data
Feb. 15, 2005 (JP) 2005-037948

(51) Int. Cl. H01H 75/00

(52) U.S. Cl. 335/16

(57) ABSTRACT

A blow-out air current guide used in an air current blow-out apparatus that has an air current blow-out portion that blows out an air current, which is supplied thereinto, in a predetermined blow-out direction. The blow-out air current guide includes an air current branching section and an air current deflecting section. The air current branching section causes a part of the air current that is blown out from the air current blow-out portion to branch as a branching air current, and the air current deflecting section substantially reverses the branching air current that is branched by the air current branching section and conducts this air current so that at least a part of the surface of the air current blow-out portion that does not face the air current flowing in the above-described predetermined blow-out direction in the air current blow-out portion is covered by the branching air current.

### BACKGROUND OF THE INVENTION

1. Field of the Invention

The present invention relates to a blow-out air current guide and an air current blow-out apparatus equipped with this air current guide.

2. Description of the Related Art

Conventional models of air current blow-out apparatuses used in air conditioning and the like includes a wide flow blow-out model and an axial flow blow-out model.

In the axial flow blow-out model, a nozzle type apparatus and a punkah louver type apparatus are widely used. Among these types, the punkah louver type apparatus, for instance, generally is comprised of, as seen from FIG. 13, a spherical shell portion having a shape that is obtained by cutting away two opposite places in a hollow spherical shape along parallel planes, an air current blow-out tubular section having a cylindrical shape which is connected to one of the two cut-away places of the spherical shell portion, and a spherical surface holding member pivotally holding the spherical shell portion and allowing attachment to a duct.

In cases where the above-described air current blow-out apparatus is attached to a duct using a receiving seat portion with a spherical surface, the conditioned air from the duct is fed into the spherical shell portion from a cut-away place in the spherical shell portion where the air current blow-out tubular section is not attached and is blown out from the air current blow-out tubular section. The blow-out direction of the conditioned air can easily be altered, since the spherical shell portion is held so as to be free to rotate inside the spherical surface holding member. However, in cases where cooling is performed, since the spherical shell portion and air current blow-out tubular section are cooled by the conditioned air, the warm air and humidity inside a room cause condensation to be generated on the outside surfaces of the spherical shell portion and air current blow-out tubular section, which is undesirable.

Accordingly, for performing cooling, it has been demanded that the generation of condensation on the spherical shell portion or air current blow-out tubular section by warm air and humidity in a room is prevented. Typical examples meeting such demand are disclosed in, for instance, Japanese Utility Model Application Publication (Kokoku) No. H3-50345 and in Japanese Utility Model Application Laid-Open (Kokai) No. H6-2047.

In the Japanese Utility Model Application Publication (Kokoku) No. H3-50345, as shown in FIG. 13, holes are formed in the bolts 133 of the attachment portions of the spherical surface holding members 130 that attach these part to the duct 140, and the conditioned air is caused to flow so that this air covers the outside surfaces of the spherical shell portion 121 and air current blow-out tubular section 122, thus preventing warm air inside the room from directly contacting the spherical shell portion 121 or air current blow-out tubular section 122, so that no condensation is generated on the outside surfaces of the spherical shell portion or air current blow-out tubular section.

In the Japanese Utility Model Application Laid-Open (Kokai) No. H6-2047, as shown in FIG. 14, an adiabatic cylindrical body 150 is used so that the conditioned air does not directly contact the air current blow-out portion 220 consisting of a spherical shell portion 221 and air current blow-out tubular section 222.

However, in the case of the above-described the Japanese Utility Model Application Publication (Kokoku) No. H3-50345, there are limits to the number of bolts and size of the holes formed in these bolts, so that the size cannot be reduced; furthermore, a diffusion-preventing cover must be installed in order to prevent diffusion of the conditioned air from the bolts. Moreover, if the orientation of the blow-out direction from the air current blow-out tubular section is varied, the conditioned air flowing over the outside surfaces of the spherical shell portion and air current blow-out tubular section is biased so that the flow becomes non-uniform, and there is a danger that places where condensation cannot be prevented will be generated.

In the case of the Japanese Utility Model Application Laid-Open (Kokai) No. H6-2047, it is not easy to mount an adiabatic cylindrical body in the air current blow-out portion; and particularly, it is not easy to mount such a cylindrical body in existing air current blow-out apparatus.

### BRIEF SUMMARY OF THE INVENTION

The present invention was devised in order to solve the above-described problems.

The object of the present invention is to provide a blow-out air current guide which can easily be mounted in an air current blow-out apparatus and which can suppress the generation of condensation, and to provide an air current blow-out apparatus that is equipped with this air current guide.

The above object is accomplished by a unique structure of the present invention for a blow-out air current guide which is installed in an air current blow-out apparatus that has an air current blow-out portion that blows out an air current, which is supplied thereinto, in a predetermined blow-out direction; and in the present invention, the blow-out air current guide is comprised of:
an air current branching section which causes a part of the air current that is blown out from the air current blow-out portion to branch as a branching air current, and
an air current deflecting section which substantially reverses the branching air current that is branched by the air current branching section and conducts this air current so that at least a part of the surface of air current blow-out portion that is not facing the air current flowing in the above-described predetermined blow-out direction is covered by the air current deflecting section.

In this structure, mounting of the blow-out air current guide on the air current blow-out apparatus can be done easily, and at least a part of the air current blow-out portion is covered by branching air current as in a form of an air curtain, so that the generation of condensation by the temperature difference on the surface of the air current blow-out portion is suppressed.

In the blow-out air current guide constructed as described above, it is preferable that the air current deflecting section be disposed so that it extends from the end portion of the air current branching section on the downstream side in the above-described predetermined blow-out direction.

The blow-out air current guide constructed as described above may take a structure in which
at least a part of the air current blow-out portion is formed in a substantially tubular shape,
the blow-out air current guide is provided in the air current blow-out apparatus by inserting the air current branching section into the substantially tubular portion of the air current blow-out portion, and
the blow-out air current guide has mounting portions which are disposed in a plurality of locations on the air current branching section that faces, when the blow-out air current guide is installed in the air current blow-out portion, the inside surface of the substantially tubular portion of the air current blow-out portion, so that the mounting portions press against the inside surface of the substantially tubular portion of the air blow-out section with a specified pressing force.

More specifically, the mounting portions can be formed so as to extend from a plurality of locations on the outside surface of the air current branching section and to be set at dimensions (external diameter) such that an appropriate resistance to removal is generated when the air current branching section is inserted into the substantially tubular portion, thus preventing easy removal of the air current branching section.
The blow-out air current guide constructed as described above may take a structure in which
at least a part of the air current blow-out portion is formed in a substantially tubular shape,
the blow-out air current guide is provided in the air current blow-out apparatus by inserting the air current branching section into the substantially tubular portion of the air current blow-out portion, and
the blow-out air current guide has mounting portions which are disposed in a plurality of locations on the air current branching section that faces, when the blow-out air current guide is provided in the air current blow-out portion, the inside surface of the substantially tubular portion of the air current blow-out portion and which are fastened by means of screws to the substantially tubular portion of the air blow-out section.

The above-described mounting portions may take a structure that includes hollow spacers and screw-fastened members; and the spacers are disposed between the air current branching section and the air current blow-out portion, and the disposed spacers are fastened between the air current branching section and the air current blow-out portion by means of the screw-fastened members.

Thus, with a structure in which the air current branching section of the blow-out air current guide is detachable with respect to the substantially tubular portion of the air current blow-out portion, it is also possible to facilitate the additional mounting of such a blow-out air current guide on an existing air current blow-out apparatus on which no blow-out air current guide is provided.

Furthermore, in the blow-out air current guide of the present invention constructed as described above, it is also possible to employ a structure in which the blow-out air current guide has an additional air current deflecting section disposed with a gap between this air current deflecting section and the surface of the air current deflecting section on the side facing the branching air current, so that the branching air current that is branched by the air current branching section is substantially reversed in two layers.

In the above-described blow-out air current guide, it is preferable that the blow-out air current guide be formed of a material that has a lower thermal conductivity than the air current blow-out portion. The present invention is indeed not limited to this structure, and it is also be possible to use a structure wherein a material with a lower thermal conductivity than that of the air current blow-out portion is pasted or applied as a coating to at least a part of the blow-out air current guide. In this structure, the blow-out air current guide itself is resistant to condensation.

Furthermore, the above-described object is accomplished by a unique structure of the present invention for an air current blow-out apparatus that is comprised an air current blow-out portion that blows out an air current, which is supplied thereinto, in a predetermined blow-out direction, and the blow-out air current guide constructed as described above.

In the air current blow-out apparatus of the present invention, it is preferable that at least a part of the side of the air current blow-part on which the air current is supplied is formed as a substantially spherical surface, and the air current blow-out apparatus has a spherical surface holding member which holds the substantially spherical surface portion of this air current blow-out portion so that this portion is pivotable within a predetermined range. Thus, even in an air current blow-out apparatus in which the direction of air current blow out can be altered, since the blow-out air current guide tilts together with the air current blow-out portion, the branching air current covers at least a part of the air current blow-out portion at all times.

As seen from the above, according to the present invention, the air current branching section of the blow-out air current guide can cause a part of the air current that is blown out from the air current blow-out portion to branch as a branching air current, and the air current deflecting section can substantially reverse the flow of the branching air current that is caused to branch by the air current branching section, so that this reversed branching air current can be caused to flow in such a manner that this air current covers at least a part of the outside surface of the air current blow-out portion.

Furthermore, since the air current deflecting section extends from one end of the air current branching section, the reversed air current can be maintained in the same state with respect to the air current blow-out portion even if the blow-out direction of the air current blow-out portion is altered. Accordingly, the generation of condensation can be suppressed regardless of the attitude of the air current blow-out portion.

Furthermore, since the air current branching section of the blow-out air current guide is detachable from the air current blow-out tubular section via the mounting portion, the blow-out air current guide can be used in an existing air current blow-out apparatus on which no blow-out air current guide is mounted.

### BRIEF DESCRIPTION OF THE SEVERAL VIEWS OF THE DRAWINGS

FIG. 1 is an external view of the first type of the air current blow-out apparatus according to the present invention;

FIG. 2 is a vertical sectional view thereof;

FIG. 3 is a vertical sectional view of the air current blow-out portion of the air current blow-out apparatus of FIG. 1;

FIG. 4 is a front view of the blow-out air current guide of the air current blow-out apparatus of FIG. 1;

FIG. 5 is a rear view of the blow-out air current guide of FIG. 4;

FIG. 6 is a sectional view of the blow-out air current guide taken along the line 6-6 in FIG. 5;

FIG. 7 is a sectional view of the blow-out air current guide taken along the line 7-7 in FIG. 5;

FIG. 8 is an exploded perspective view showing the manner of mounting of the blow-out air current guide 10 on the air current blow-out tubular section 22;

FIG. 9 is an external view of another type of the air current blow-out apparatus according to the present invention;

FIG. 10 is a sectional view of the air current blow-out apparatus shown in FIG. 9 as seen from an imaginary line that does not pass through the mounting portion;

FIG. 11 is a sectional view of the air current blow-out apparatus shown in FIG. 9 as seen from an imaginary line that passes through the mounting portion;

FIG. 12 is an exploded perspective view showing the manner of installing the blow-out air current guide in the air current blow-out tubular section;

FIG. 13 is a sectional view of a conventional example of an air current blow-out apparatus; and

FIG. 14 is a sectional view of another conventional example of an air current blow-out apparatus.

### DETAILED DESCRIPTION OF THE INVENTION

The blow-out air current guide and air current blow-out apparatus present invention will be described below with reference to the accompanying drawings.

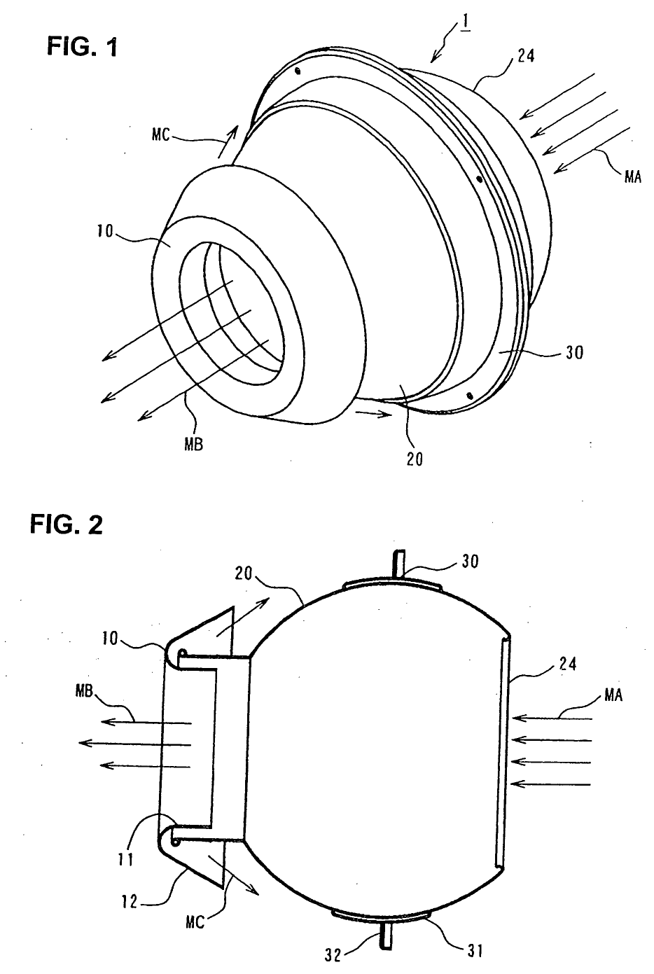

The air current blow-out apparatus 1 shown in FIGS. 1 and 2 is comprised of a blow-out air current guide 10, an air current blow-out portion 20, and a spherical surface holding member 30.

Conditioned air (an air current supplied thereinto) MA (e.g., air used for cooling) that is fed from a conditioned air supply source via a duct or the like (not shown) is supplied to a conditioned air supply port 24, and it passes through the air current blow-out portion 20 and blow-out air current guide 10. For the most part of the air MA is blown out directly into the room (in the predetermined blow-out direction) as a main air current MB; and, a part of the supplied conditioned air MA is branched separately from the main air current MB by the blow-out air current guide 10 to form a reversed air current (branching current) MC, and this air current MC is blown out in substantially the opposite direction from the direction of the conditioned air supply source, i.e., the direction of the conditioned air MA and main air current MB, so as to cover all or part of the outside surface of the air current blow-out portion 20, thus preventing condensation on the outside surface of the air current blow-out portion 20.

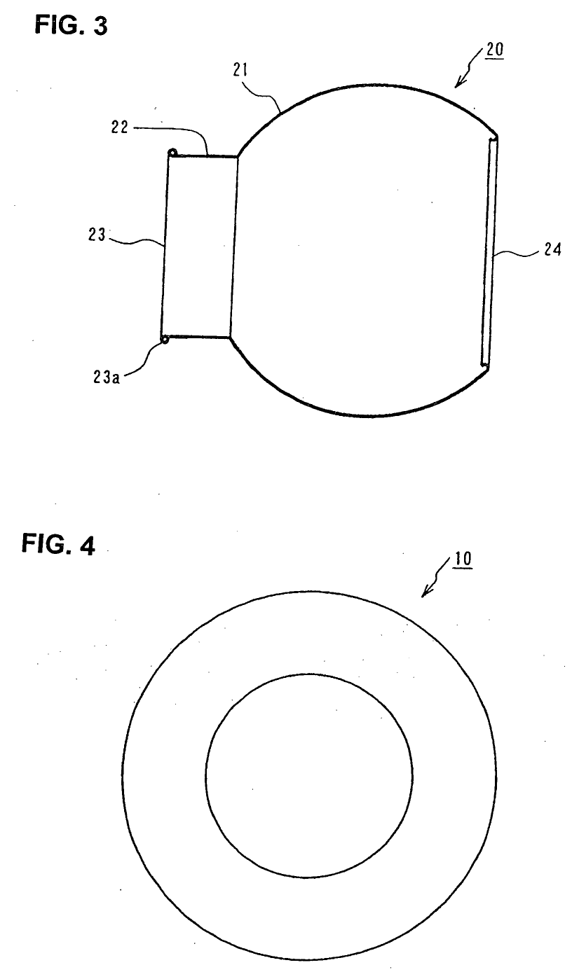

In the shown example, the air current blow-out portion 20 is made of metal, and it has a spherical shell portion 21 and an air current blow-out tubular section 22 as shown in FIG. 3. The spherical shell portion 21 has a shape (substantially spherical surface shape) in which two opposite places on a hollow sphere are cut as parallel planes, while the air current blow-out tubular section 22 has a shape that extends in cylindrical form (substantially tubular form) from one cut-away location on the spherical shell portion 21. Accordingly, when conditioned air MA is supplied from a conditioned air supply port located in the other cut-away place on the spherical shell portion 21, this conditioned air passes or flows through the spherical shell portion 21 and air current blow-out tubular section 22, and then it is blown out from the air current blow-out port 23.

As shown in FIGS. 2, 4, 5, 6 and 7, the blow-out air current guide 10 has an air current branching section 11, an air current deflecting section 12 and mounting portions 13. The air current branching section 11, air current deflecting section 12 and mounting portions 13 are integrally formed of a plastic material.

The air current branching section 11 has a cylindrical shape, and the external diameter of this air current branching section 11 is set to be smaller than the internal diameter of the air current blow-out tubular section 22. The air current branching section 11 causes a part of the air current that is blown out from the air current blow-out portion 20 to branch as a branching air current MC.

The air current deflecting section 12, as best shown in FIG. 2, extends radially outward from the downstream end (left side in FIG. 2) of the air current branching section 11 in a predetermined blow-out direction. The air current deflecting section 12 is folded back in the form of an umbrella and extends toward the other end (right side in FIG. 2) of the air current branching section 11.

The air current deflecting section 12 substantially reverses the branching air current that is branched by the air current branching section 11 and conducts this air current so that this air current covers (or flows along) at least a part of the of the surface of the air current blow-out portion 20 on the side that does not face the air current flowing in the predetermined blow-out direction.

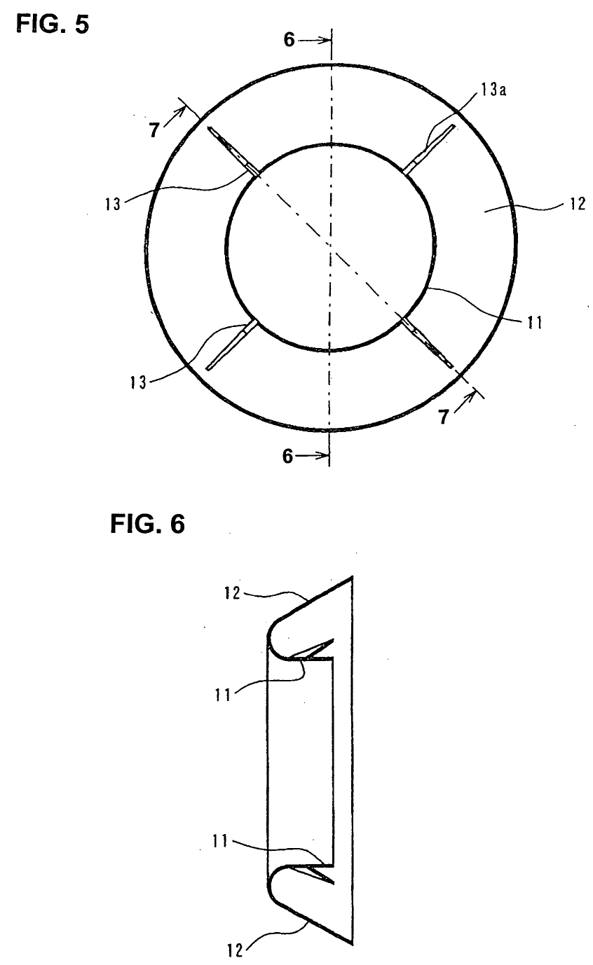

The blow-out air current guide 10 is mounted on the air current blow-out apparatus by inserting the air current branching section 11 into the air current blow-out tubular section 22 in the air current blow-out portion 20. Mounting portions 13 which are used to press the inside surface of the air current blow-out tubular section 22 with a specified pressing force are disposed in a plurality of locations (see FIG. 5) on the air current branching section that faces the inside surface of the air current blow-out tubular section 22. In the shown example, the mounting portions 13 consist of four plates that are disposed every 90 degrees, and they are formed so that the plate surfaces are oriented at right angles to the outer circumferential surface of the air current branching section 11.

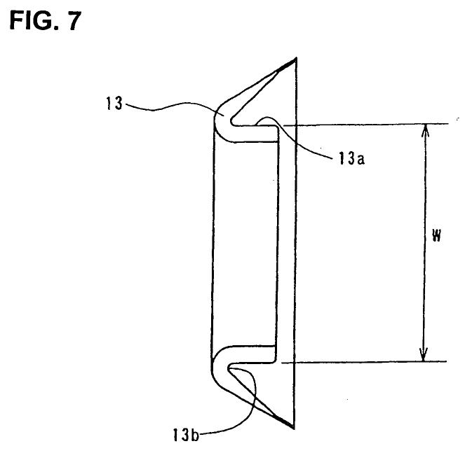

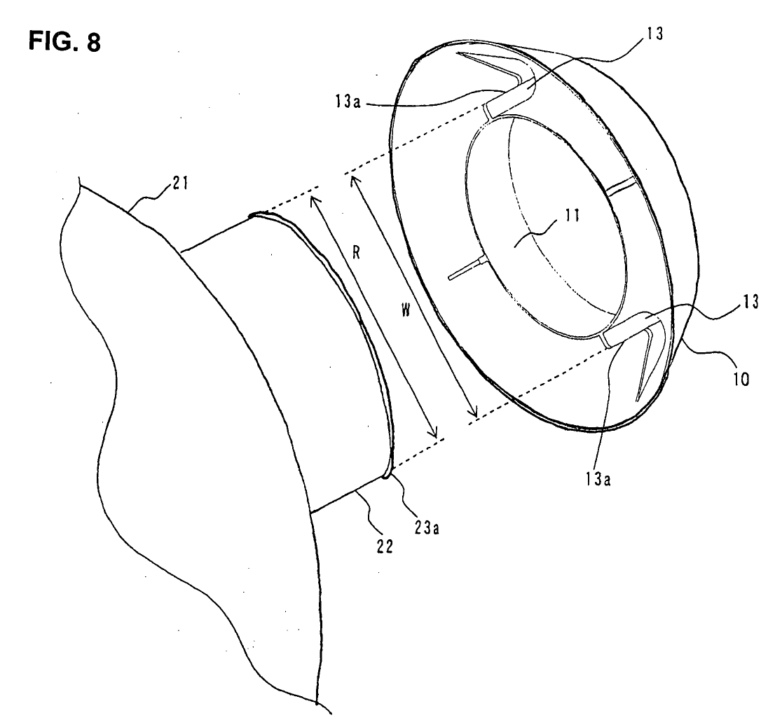

When the above-described blow-out air current guide 10 is to be mounted in the air current blow-out tubular section 22, engaging parts 13a of the mounting portions 13 (see FIGS. 5, 7 and 8) are press fitted so that they are in contact with the inside wall of the air current blow-out tubular section 22. As a result of this press fitting, the air current branching section 11 and the air current blow-out tubular section 22 are slightly deformed so that an elastic force is exerted on the engaging parts 13a, thus causing the air current blow-out tubular section 22 to hold the blow-out air current guide 10. In this case, as seen from FIG. 7, the width W of the engaging parts 13a is set so that the blow-out air current guide 10 can be pulled out of the air current blow-out tubular section 22 (here, the internal diameter is designated as R) if an appropriate tensile force is applied to the blow-out air current guide 10.

Accordingly, attachment and removal of the blow-out air current guide 10 are extremely easy, and the blow-out air current guide 10 can be installed in an existing air current blow-out apparatus of the same type as described above and on which no blow-out air current guide 10 is provided. Furthermore, in the example described above, the width W of the engaging parts 13a demarcates the passage of the branching air current, i.e., the flow rate of the branching air current. Furthermore, when the blow-out air current guide 10 is press fitted as set in the air current blow-out tubular section 22, the end 23a of the air current blow-out port 23 (FIG. 3) contacts the contact parts 13b of the mounting portions 13, thus determining the distance in the depth direction to which press fitting can be accomplished.

Furthermore, in the above-described structure, the blow-out air current guide 10 is integrally formed of a plastic material. However, it is also possible to form this blow-out air current guide from a metal material; and in this case, it is possible to omit mounting portions 13 that are integrated with the blow-out air current guide, and instead to prepare a cylindrical spacer having a length that is substantially the same as the width W of the engaging parts 13a, to dispose this spacer between the blow-out air current guide 10 and the air current blow-out tubular section 22, and to fasten these parts by means of nuts and bolts that pass through the spacer. In this case, of course, it is also possible (instead of using nuts) to form holes on the blow-out air current guide, form taps on the air current blow-out tubular section, and to fasten these parts with bolts. Some other configurations can be indeed employed, as long as the blow-out air current guide 10 is detachably attached in a stipulated position on the air current blow-out tubular section 22. Thus, it is possible to employ a structure that uses parts (corresponding to mounting portions) which are disposed in a plurality of places on the air current branching section 11 facing the inside surface of the air current blow-out tubular section 22 and are screw-fastened to the air current blow-out tubular section 22.

As seen from FIGS. 1 through 3, the spherical surface holding members 30 includes a spherical surface receiving seat portion 31 and a duct connecting portion 32. The spherical surface receiving seat portion 31 holds the spherical shell portion 21 of the air current blow-out portion 20 so that the spherical shell portion 21 is pivotable within a specified range. Accordingly, the blow-out direction of the main air current MB can be altered within the range in which the spherical shell portion 21 is pivoted in the spherical surface holding member 30. In this case, since the blow-out air current guide 10 is fastened to the air current blow-out port 23, the blow-out state of the reversed air current MC on the outside surface of the air current blow-out portion 20 is not varied greatly even if the blow-out direction of the main air current MB is altered, so that condensation can be prevented in a stable and favorable manner. Furthermore, the duct connecting portions 32 can be in a small size, since it is sufficient for the duct connecting portions 32 to make a connection with the duct or conditioned air supply passage.

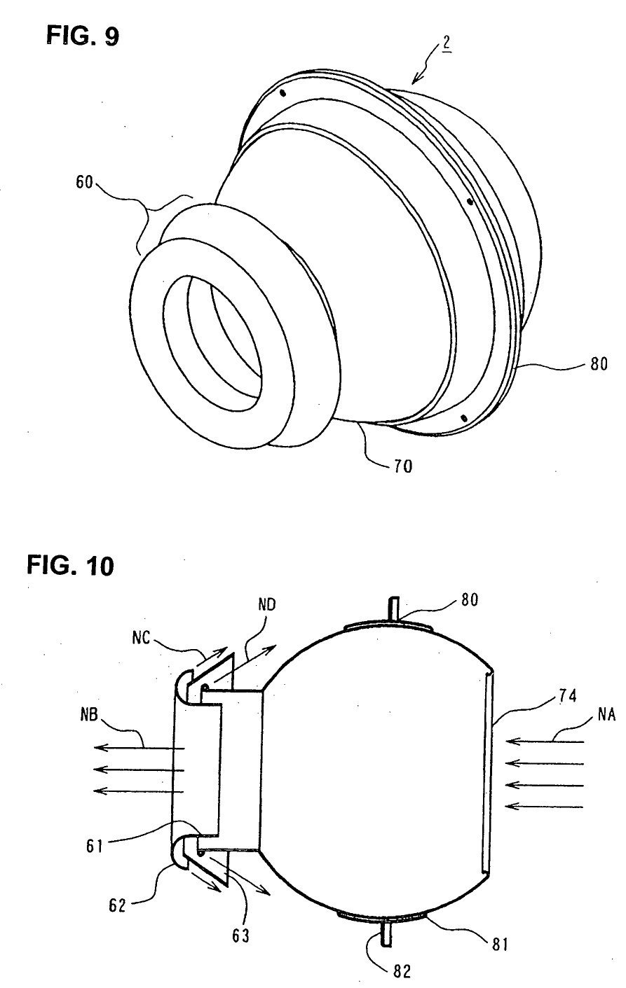

Next, another type of the air current blow-out apparatus will be described with reference to FIGS. 9 through 12.

The air current blow-out apparatus 2 shown in FIGS. 9 through 12 is comprised of a blow-out air current guide 60, an air current blow-out portion 70 and a spherical surface holding member 80.

Conditioned air (air current) NA (fed from a conditioned air supply source via a duct or the like (not shown)) is supplied to a conditioned air supply port 74. The most part thereof is blown directly into the room as a main air current NB via the air current blow-out portion 70 and blow-out air current guide 60; and a part of the supplied conditioned air NA is formed into reversed air currents NC and ND that are separate from the main air current NB by the blow-out air current guide 60, and these air currents are blown out in the direction of the conditioned air supply source, i.e., the opposite direction of the conditioned air NA and NB, so that two layers of reversed air currents NC and ND cover (and flow along) the outside surface of the air current blow-out portion 70.

As described above, the air current blow-out apparatus 2 shown in FIGS. 9 through 12 differs from the air current blow-out apparatus 1 shown in FIGS. 1 through 8 in terms of the blow-out air current guide 60.

More specifically, the blow-out air current guide 60 in FIGS. 9 through 12 includes an air current branching section 61, a first air current deflecting section 62, a second air current deflecting section 63, and mounting portions 64′.

The blow-out air current guide 60 has a structure in which a second air current deflecting section 63 (additional air current deflecting section 63) is provided with a gap left on the surface on the side that faces the branching air current of the first air current deflecting section 62, so that the branching air current that is branched by air current branching section 61 is substantially reversed in two layers.

Though the structure of the mounting portions 64′ may be the same as in the case shown in FIGS. 1 through 8, in order to stabilize the positional relationship between the first current deflecting portion 62 and the second current deflecting portion 63, it is also possible to design the first and second current deflecting portion 62 and 63 are provided to be parallel (to form parallel plate-form members) that extend in the direction in which the blow-out air current guide 60 is inserted into the air current blow-out tubular section 72.

With the structure described above, it is possible to install a mounting element 63a on the second air current deflecting section 63, and to clamp this mounting element 63a with the mounting portions 64′ when the blow-out air current guide 60 is installed in the air current blow-out tubular section 72, so that the second air current deflecting section 63 can be held more securely.

In the above structure, since the reversed air current consists of two layers as the reversed air currents NC and ND, the temperature variation is gradual, so that the generation of condensation on the surface of the air current blow-out portion 70 is also further reduced.

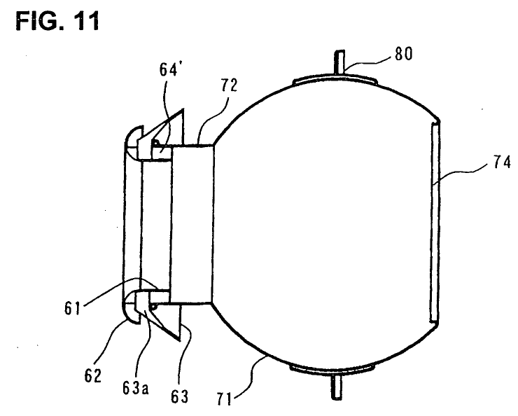

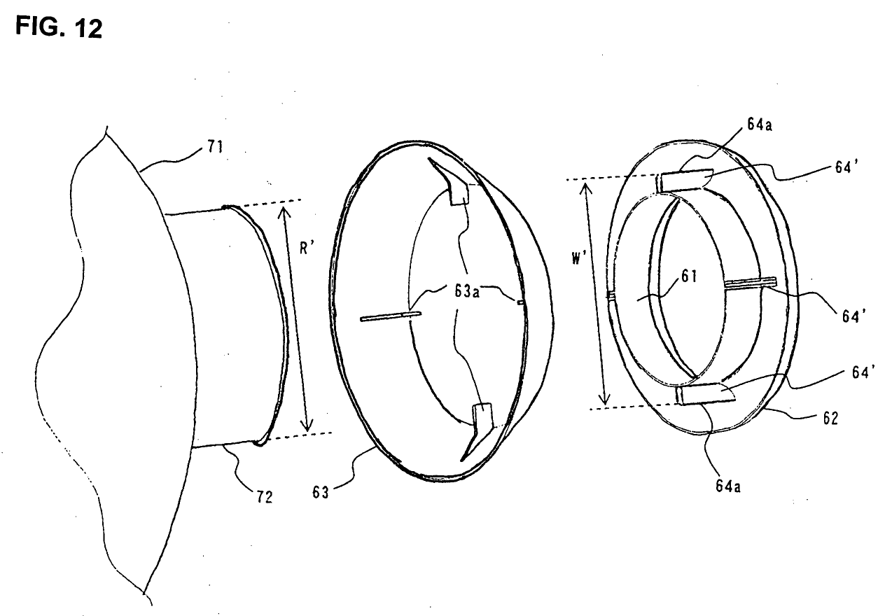

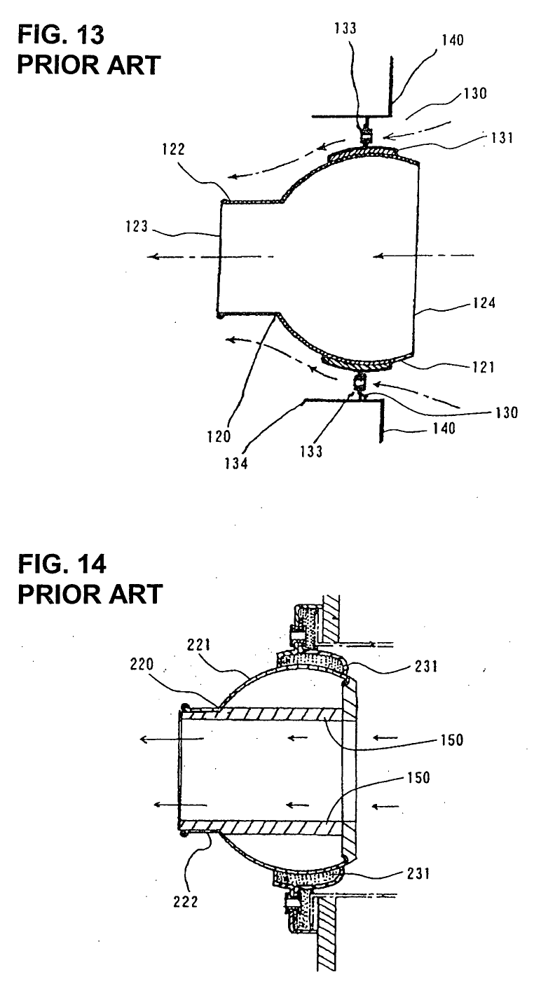

Like in the structure described in FIGS. 1 through 8, when the blow-out air current guide 60 is provided in the air current blow-out tubular section 72, the engaging parts 64a of the mounting portions 64 (see FIGS. 11 and 12) are press fitted to make a contact with the inside wall of the air current blow-out tubular section 72. As a result of this press fitting, the air current branching section 61 and air current blow-out tubular section 72 undergo a slight deformation and exert an elastic force on the engaging parts 64a, so that the air current blow-out tubular section 72 holds the blow-out air current guide 60.

The width W′ (see FIG. 12) of the engaging parts 64 is determined so that if an appropriate tensile force is applied to the blow-out air current guide 60, the blow-out air current guide 60 can be pulled out of the air current blow-out tubular section 72 (here, the internal diameter of the air current blow-out tubular section 72 is referred to as R′).

In the respective examples described above, it is preferable that the blow-out air current guides 10 and 60 be formed of a material with a lower thermal conductivity than the air current blow-out portions 20 and 70 for the purpose of preventing the generation of condensation. When the blow-out air current guides 10 and 60 are made of metal, it is preferable that a material with a lower thermal conductivity than the air current blow-out portions 20 and 70 be pasted to the guides in order to prevent the generation of condensation. Instead of pasting, a material with a low thermal conductivity may also be applied as a coating.

The present invention is not limited to those described above; and in the actual working stage, various modifications can be made within the concept of the present invention, and the respective effects can be obtained by appropriately combining the respective examples.

1. A blow-out air current guide which is provided in an air current blow-out apparatus which has an air current blow-out portion that blows out an air current, which is supplied thereinto, in a predetermined blow-out direction, said blow-out air current guide comprising:
an air current branching section which causes a part of the air current that is blown out from said air current blow-out portion to branch as a branching air current; and
an air current deflecting section which substantially reverses the branching air current that is branched by said air current branching section and conducts the branching air current to cover at least a part of an exterior surface of said air current blow-out portion.

2. The blow-out air current guide according to claim 1, wherein said air current deflecting section is disposed so as to extend from an end portion of said air current branching section on a downstream side in said predetermined blow-out direction.

3. The blow-out air current guide according to claim 1, wherein
at least a part of said air current blow-out portion is formed in a substantially tubular shape,
said blow-out air current guide is provided in said air current blow-out apparatus by being inserted in said substantially tubular portion of said air current blow-out portion, and
said blow-out air current guide has mounting portions which are disposed in a plurality of locations on said air current branching section that faces an inside surface of said substantially tubular portion of said air current blow-out portion so that said mounting portions press against an inside surface of said substantially tubular portion of said air blow-out section with a specified pressing force.

4. The blow-out air current guide according to claim 1, wherein
at least a part of said air current blow-out portion is formed in a substantially tubular shape,
said blow-out air current guide is provided in said air current blow-out apparatus by inserting said air current branching section into said substantially tubular portion of said air current blow-out portion, and
said blow-out air current guide has mounting portions which are disposed in a plurality of locations on said air current branching section that faces an inside surface of said substantially tubular portion of said air current blow-out portion so that said mounting portions are screwed to said substantially tubular portion of said air blow-out section.

5. The blow-out air current guide according to claim 1, further comprising an additional air current deflecting section provided between said air current deflecting section and said air current blow-out portion so that the branching air current that is branched by said air current branching section is substantially reversed in two layers.

6. The blow-out air current guide according to claim 1, wherein said blow-out air current guide is formed of a material that has a lower thermal conductivity than said air current blow-out portion.

7. The blow-out air current guide according to claim 1, wherein a material that has a lower thermal conductivity than said air current blow-out portion is provided as a coating on at least one portion of a surface of said blow-out air current guide.

8. An air current blow-out apparatus comprising:
an air current blow-out portion that blows out an air current, which is supplied into the air current blow-out apparatus, in a predetermined blow-out direction; and
the blow-out air current guide according to any one of claims 1 through 6.

9. The air current blow-out apparatus according to claim 8, wherein
at least a part of one end of said air current blow-out portion on which the air current is supplied is formed as a substantially spherical surface, and
said air current blow-out apparatus has a spherical surface holding member which holds a substantially spherical surface portion of said air current blow-out portion so that said substantially spherical surface portion is pivotable within a predetermined range.
